(19) United States
(12) Patent Application Publication
(10) Pub. No.: US 2010/0245667 A1
(43) Pub. Date: Sep. 30, 2010

(54) NON-STANDALONE TV PC

(75) Inventors: Robert HARDACKER, Escondido, CA (US); Christopher Jensen READ, San Diego, CA (US); Robert Allan UNGER, El Cajon, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/409,795

(22) Filed: Mar. 24, 2009

(51) Int. Cl. H04N 7/00

(52) U.S. Cl. 348/552; 348/E07.001

(57) ABSTRACT

A TV includes a TV processor and a TV display and a PC includes a PC processor but no PC monitor. A HDMI link is established between the processors for conveying multimedia content from the PC to the TV for display thereof on the TV display. Also, a link such as a USB link is established between the processors for exchanging control signals therebetween.

### FIELD OF THE INVENTION

The present invention relates generally to a TV enhancement to include portable computer (PC) functionality such that it becomes an all-in-one TV-PC.

### BACKGROUND OF THE INVENTION

The venerable “rabbit ears” TV antennas have become a rarity on the modern TV, which instead typically receives cable TV signals and/or satellite TV signals and/or recorded content from sources such as, e.g., digital video recorders (DVR) and digital video disk (DVD) players through a receiver broadly referred to as a “set top box” (STB). A type of STB is the so-called “set back box” (SBB) which differs from a STB chiefly by being controlled by the same remote control that controls the TV.

With the advent of high resolution digital TVs such as high definition TVs (HDTVs), to extend communication protocols to digital multimedia that includes audio for the purpose of, e.g., playing digital movies and the like, a protocol referred to as High Definition Multimedia Interface (HDMI) has been developed. HDMI is similar to Digital Visual Interface (DVI), a protocol developed primarily for computers that consequently does not envision processing audio data, except that HDMI envisions the use of audio as well as video data and it adds television-related resolutions. Both DVI and HDMI are intended for wired transmission, and HDMI further permits the encryption of digital multimedia using an encryption method known as High-Bandwidth Digital Content Protection (HDCP), which may also be used with DVI. An advantageous feature of HDMI is that it supports consumer electronics control (CEC), which permits control of the source (SB/DVD player/DVR etc.) and the TV using a single remote control.

The idea of an all-in-one TV/PC is beginning to take hold for some consumers. Unfortunately, systems packaging a PC in a TV typically have small screens. A desktop PC can be attached to a TV to use the TV as the PC display but as understood herein, control between the TV and PC typically is disjointed. Furthermore, use of a desktop PC impedes compact, efficient packaging of the combined system. These disadvantages arise in part because PCs have evolved beginning with a desktop box with a computer case and separate monitor which in turn has evolved into laptops, notebooks, netbooks, etc. As understood herein, a purpose-built standalone TV may be provided to extend the PC functionality as an add-on module.

### SUMMARY OF THE INVENTION

Accordingly, the present invention recognizes that a PC may be tightly coupled to a relatively large screen TV in a way in which TV/PC control is not disjointed.

The PCs may be provided as a family of PCs with different features that can marry to a family of purpose-built TVs. For example, a non-standalone PC may be nothing more than a single circuit board with processor, DRAM memory, and a communication interface to the TV. Other versions of the non-standalone PC may additionally include one or more of the following peripherals in steps such as SSD, HDD, optical disk, Ethernet, Wireless, etc., although none of the non-standalone include monitors or keyboard entry devices. However, ports to accept mice/keyboards may be provided on the circuit board.

The purpose-built standalone TV may range in size, resolution, functionality typical of a TV product line. This type of TV can fully act like a TV without the attachment of a PC module, but is enhanced to accept and incorporate seamlessly the PC module family members that provide additional functionality.

The interface between the PC and TV may be consistent with a base common architecture such as DMEX which uses USB and HDMI as disclosed further below. Other TV/PC combinations may communicate using a wireless 60 GHz connection. A higher-capability non-standalone PC module can still connect to a lower capability TV, albeit with some reduced functionality due to the familial common base I/F.

In the above instances the PC output signals for display, instead of supporting multiple resolutions, is geared toward the specific TV display and hardware functionality for which the non-standalone PC is designed. The PC thus may leverage the hardware picture enhancement capabilities of the TV, and can also add software picture enhancements that are downloadable. The PC adds additional processing speed, memory, and software flexibility to the semi-fixed function TV, thereby retaining the primary TV form factor (e.g., a TV with a small set-back box attached in a dedicated slot/position) as opposed to requiring a separate set-top box next to the TV with a PC docked in it.

Accordingly, a TV includes a TV display and a TV processor executing logic that includes presenting on the TV display a list of input sources. The list includes a personal computer (PC) having an optical disk player. The logic executed by the TV processor also includes receiving from a wireless TV remote control (RC) a selection signal indicating that the disk player of the PC is desired as input source to the TV, receiving multimedia content from the disk player of the PC over a high definition multimedia interface (HDMI) link, and exchanging control signals over a universal serial bus (USB) link with the PC.

The PC need have no input devices other than the RC nor output devices other than the TV display. If desired, however, the PC may receive input signals from a keyboard and/or mouse.

In some embodiments the TV includes a USB host port communicating with a USB device port on the PC. The TV can also communicate with a disk player not associated with the PC, with the list of input sources including the disk player not associated with the TV.

In another aspect, a personal computer (PC) adjunct to a TV includes a PC processor and a source of multimedia content such as a network interface or an optical disk player communicating with the PC processor. A HDMI port communicates multimedia content from the source to a HDMI port of the TV over a HDMI link for display thereof on a TV display associated with the TV. Also, a USB device port of the PC receives, over a USB link, commands from the TV generated by a TV remote control (RC).

In another aspect, a TV includes a TV processor and a TV display and a PC includes a PC processor but no PC monitor. A HDMI link is established between the processors for conveying multimedia content from the PC to the TV for display thereof on the TV display. Also, a command link such as a USB link is established between the processors for exchanging control signals therebetween.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing internal components of the TV;

FIG. 2 is a screen shot of the cross-media bar (XMB) graphical user interface (GUI) for use in connection with the PC;

FIG. 3 illustrates example logic; and

FIG. 4 schematically illustrates PC/TV combinations.

### DETAILED DESCRIPTION OF THE PREFERRED EMBODIMENT

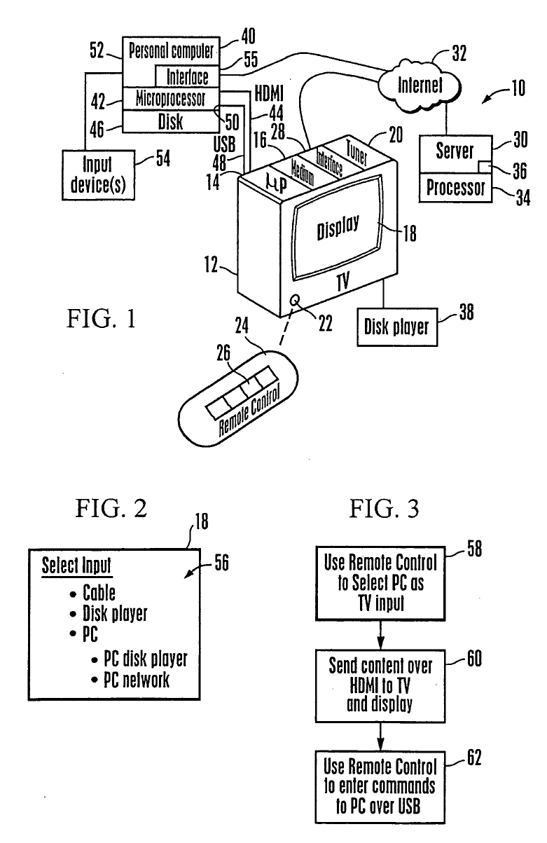

Referring initially to FIG. 1, a system is shown, generally designated 10, which includes a TV 12 having a TV processor 14 accessing a computer readable storage medium 16 such as but not limited to solid state storage and/or disk based storage to present TV signals on a TV display 18, such as a flat panel LCD display or other type of matrix display or a plasma display or other suitable type of TV display. The signals are received through a TV tuner 20 that communicate with a suitable source of TV signals. The TV 12 typically includes a wireless receiver 22 such as an infrared receiver for receiving user command signals from a remote control 24. The remote control 24 typically includes one or more manipulable input elements 26 such as keys for enabling a user to input commands to the TV processor 14.

As shown in FIG. 1, the TV 12 may also include a network interface 28 such as but not limited to a wired or wireless modem for enabling the TV processor 14 to communicate with one or more servers 30 over a wide area network such as the Internet 32. The network interface 28 may be incorporated within the chassis of the TV 12 or it may be included in a set-top box or set-back box operably engaged with the TV 12. In any case, the server 30 includes one or more server processors 34 accessing a server data storage medium 36.

An optical disk player 38 may also communicate with the TV processor 14 using HDMI as well as a universal serial bus (USB) link for control. Furthermore, a personal computer 40 can communicate with the TV processor. With more specificity, a PC processor 42 may communicate with the TV processor 14 using a HDMI link 44, over which multimedia data from, e.g., an optical disk player 46 in the PC 40 may be conveyed for display on the TV, as well as a USB link 48, over which control signals between the TV processor and the PC processor may be conveyed. Accordingly, since, as understood herein, the USB protocol is not bipolar, the USB port 50 of the PC 40 to which the USB link 48 is connected may be a device USB link, with the PC 40 also potentially including the more conventional (for PCs) host USB port 52, with USB device ports not being the same as USB host ports. The TV's USB port receiving the USB link 48 may be a USB host port, however. The PC components described above may be contained in a single PC module housing.

As envisioned herein, in some embodiments the PC 40 is not a standalone PC with all conventional PC peripheral devices. Thus, the PC 40 need not have an output device such as a printer or monitor and need not have input devices apart from the RC 24 as described below, since the PC 40 is intended as an adjunct to the TV that can augment processing and storage capacity of the system as a whole. However, if desired one or more input devices 54 such as wired or wireless keyboards, mice, etc. may be provided. In some embodiments the PC 40 has no power supply, and instead receives power from the TV. Thus, the non-standalone PC is not usable by itself without the TV.

In any case, in addition to or in lieu of the TV communicating with the Internet 32, the PC 40 may have a network interface 55 communicating with the Internet.

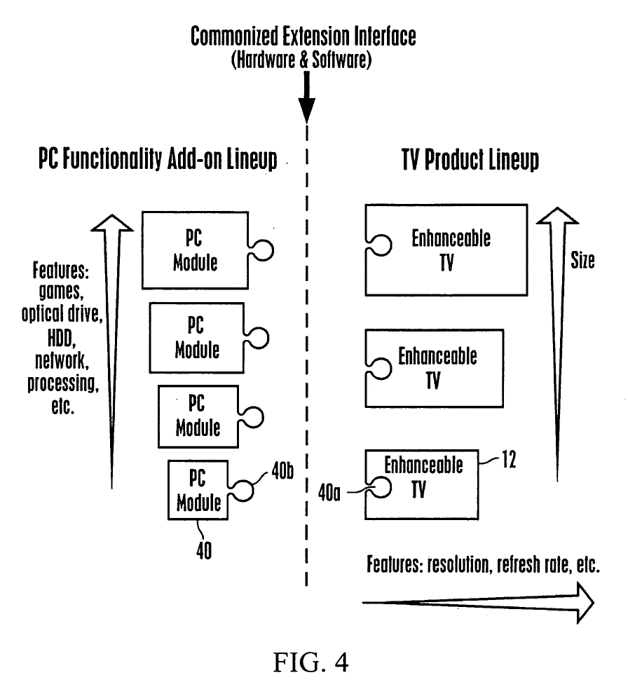

Referring briefly to FIG. 4, the PC 40 may be provided as a single circuit board (single board computer, or “SBC”). In one implementation at least a portion 40b of the PC 40 when configured as a SBC may slide into a dedicated bay 40a on the TV 12 chassis, which establishes communication between the PC processor and TV processor. The relative component sizes in FIG. 4 indicate relative capabilities as indicated. Thus, various PC 40 modules may be provided with increasing capabilities relative to each other such as game provisioning, optical disk drive provisioning, HDD provisioning, network communication provisioning, increasing processing power, etc. On the other hand, various special-built TVs 12 may be provided with increasing capabilities relative to each other such as increasing resolution, increasing refresh rates, etc. In this way, a family of possible combinations of non-standalone PCs 40 with special purpose TVs 12 (i.e., TVs configured with, for instance, the bay 40a to accept the PC) may be provided.

Now referring to FIG. 2, once the PC 40 is connected via HDMI and USB to the TV processor 14, the TV processor 14 may configure the display 18 to present a cross media bar (XMB) user interface 56 listing available sources of multimedia input for display. As shown, the XMB 56 includes a cable input and a disk player 38 input. Furthermore, the XMB 56 includes an entry for the PC 40 and/or its optical disk player 46 and/or its network connection, from which streaming multimedia may be obtained. List information as to the available titles on the PC disk player, information pertaining to the icon representing the PC that is to be displayed on the XMB, etc. may be transferred from the PC to the TV over the USB link and presented on the XMB 56.

Now referring to FIG. 3, at block 58 a user can, using the remote control 24, select from the XMB 56 the PC disk player 46 as the input source to the display 18. This causes, at block 60, content from a disk in the disk player 46 to be sent over the HDMI link 44 to the TV for presentation on the TV display 18. Furthermore, at block 62 the user can manipulate the RC 24 as appropriate to input commands over the USB link 48 (or, if desired, over the CEC component of the HDMI link) to the PC processor 42 to control the PC disk player 46. The commands can include, e.g., disk player commands such as stop, play, fast forward, skip, etc. In this way, the PC 40 is tightly coupled to the TV 12 as an adjunct multimedia processing and input source to the TV.

In variations in which input devices 54 are provided for communicating with the PC processor 42, the above selections and commands may be effected by means of the input devices 54 in lieu of the RC 24. Thus, for example, a user may use the arrow keys of a keyboard input device 54 or a user may use a mouse input device 54 to select an input source from the XMB, with the PC processor 42 relaying the selection to the TV processor 14. Or, the signals from the input devices 54 may be sent directly to the TV processor 14 without passing through the PC processor 42. In some variations, the PC processor 42 may execute conventional PC tasks such as, for example, word processing, in which case the PC processor 42 uses the TV display 18 as an output device to, e.g., present over the HDMI link 44 or USB link 48 the text of a document being executed by the PC processor 42 using a word processing application.

While the particular NON-STANDALONE TV PC is herein shown and described in detail, it is to be understood that the subject matter which is encompassed by the present invention is limited only by the claims.

What is claimed is:

1. A portable computer (PC)-TV combination creating an all-in-one PC-TV providing full PC and full TV functionality, including keyboard, mouse, display, mass storage, processing power, TV tuning, USB ports, and network connection.

2. The combination of claim 1, wherein the combination also has: WiFi, PVR, optical disk, flash card readers, hard disk, and extensive PC software.

3. The combination of claim 1, wherein the PC is incomplete without the TV in that the PC has no monitor and is not usable without the TV.

4. The combination of claim 1, wherein the TV is complete in that the TV can function as a normal TV without the PC.

5. The combination of claim 1, comprising an interface for connecting the PC to the TV that goes beyond basic HDMI, which allows video from the PC to be sent to the TV as well as sophisticated control and data exchange between the two.

6. The combination of claim 5, wherein the interface includes HDMI and a USB port, the PC having a device USB port or an on-the-go USB port, instead of or in addition to a host USB port.

7. The combination of claim 1, wherein the PC can fit multiple TV sizes for flexible TV selection.

8. The combination of claim 1, wherein the TV can accept a wide range of PC capabilities including memory, processor, graphics, disk, optical drive to support flexible PC selection.

9. The combination of claim 1, wherein the PC can be upgraded by swapping it out with another PC.

10. The combination of claim 5, wherein the PC can be moved from one TV to another TV that supports the interface.

11. TV including a TV display and a TV processor executing logic comprising:
presenting on the TV display a list of input sources, the list including a personal computer (PC) having an optical disk player;
receiving from a wireless TV remote control (RC) a selection signal indicating that the disk player of the PC is desired as input source to the TV;
receiving multimedia content from the disk player of the PC over a high definition multimedia interface (HDMI) link in response to the selection signal;
receiving commands from the RC to control the disk player of the PC; and
exchanging control information over a universal serial bus (USB) link with the PC.

12. The TV of claim 11 wherein the PC has no input devices other than the RC.

13. The TV of claim 11, wherein the TV includes a USB host port communicating with a USB device port on the PC.

14. The TV of claim 11, wherein the TV also communicates with a disk player not associated with the PC, the list of input sources including the disk player not associated with the TV.

15. The TV of claim 11, wherein the PC receives input signals from a keyboard and/or mouse.

16. A personal computer (PC) adjunct to a TV comprising:
a PC processor;
a source of multimedia content communicating with the PC processor;
a HDMI port communicating multimedia content from the source to a HDMI port of the TV over a HDMI link for display thereof on a TV display associated with the TV; and
a USB device port exchanging over a USB link control signals with the TV.

17. The PC of claim 16, wherein the source is an optical disk.

18. The PC of claim 16, wherein the source is a network interface.

19. The PC of claim 16, wherein the PC includes a USB host port.

20. The PC of claim 16, wherein the PC has no output device other than the TV display.
